(19) United States
(12) Patent Application Publication
(10) Pub. No.: US 2004/0026676 A1
(43) Pub. Date: Feb. 12, 2004

(54) Modular sheave assemblies

(76) Inventors: Rory Stephen Smith, El Cajon, CA (US); Patrick M. Bass, Lakeside, CA (US); Craig Bull, La Quinta, CA (US); San Aranggi Soemardjan, El Cajon, CA (US)

Correspondence Address: WHITE & CASE LLP, PATENT DEPARTMENT, 1155 AVENUE OF THE AMERICAS, NEW YORK, NY, 10036, US

(21) Appl. No.: 10/391,666

(22) Filed: Mar. 19, 2003

Related U.S. Application Data
(60) Provisional application No. 60/401,636, filed on Aug. 6, 2002.
(60) Provisional application No. 60/403,447, filed on Aug. 13, 2002.

(51) Int. Cl. B66D 3/08

(52) U.S. Cl. 254/393; D08/360

(57) ABSTRACT

The invention provides modular drive and deflector sheave assemblies for raising and lowering elevator cars and for deflecting a support rope or cable in different directions with minimal wear. The drive sheave assemblies of the invention provide sufficient traction between a support rope, e.g., nylon-jacketed Kevlar suspension rope, and sheave to raise and lower elevator cars without requiring more than 180° of contact between the rope and drive sheave. Such a drive sheave assembly can advantageously have a non-rope-pinching groove, thereby minimizing wear on the rope and vibration during operation.

This application claims priority to U.S. provisional application serial Nos. 60/401,636, filed Aug. 6, 2002, and 60/403,447, filed Aug. 13, 2002, each of which is hereby incorporated by reference in its entirety.

### FIELD OF THE INVENTION

The field of the invention is that of elevators and cable and rope lifting systems.

### BACKGROUND OF THE INVENTION

In all traction elevators, the groove of a driving sheave must have a profile such that the required amount of traction can be developed within the permissible angle of contact between the rope and the groove. In single wrap elevators with overhead machines, the angle of contact can be a small as 145° but is never larger than 180°. In single wrap elevators with machines below, the degree of contact may be as much as 220°. To keep the wear of the grooves to a minimum, it is necessary to provide ample bearing surface for the ropes. This is generally accomplished by providing several ropes, each supported in its own sheave groove. (Electric Elevators, Book I, F. Hymans, Intl. Textbook Co., pp. 23-24.)

When the angle of contact between the hoist/support ropes and drive sheave is small, so-called rope-pinching sheave grooves have been employed to increase the traction between the rope and sheave grooves. However, elevator systems utilizing pinching-type sheaves are limited to slower, non-high-speed operation due to the wear and tear on the ropes and sheaves and due to the vibration associated with such systems. For example, a common rope-pinching configuration is the V-groove. Elevator operating speed is generally limited to about 125 feet per minute with a V-groove system. Another rope-pinching configuration is the undercut U-groove. Elevator operating speeds are generally limited to about 600 feet per minute, i.e., the medium speed range, with the undercut-U-groove. (Electric Elevators, Book I, F. Hymans, Intl. Textbook Co., pp. 25-26.)

A substantially non-pinching-type groove, such as a U-groove, causes the least amount of damage and wear to the rope and sheave groove itself but provides poor traction between the sheave and rope. In fact, about 270° of contact between the sheave and rope is required to obtain a workable amount of traction with a U-groove system. However, this degree of contact is not obtainable using a single wrap elevator system. Certain prior art systems have provided metallic sheaves which form a rope-engaging groove which is then lined with synthetic material to increase the traction between the sheave and a rope running therein. However these liners are not suitable for rugged or high speed applications. Firstly, since the liners are thin, they have a very limited workable lifetime due to wear. Secondly, a potentially hazardous situation exists when these liners are worn through since a rope running in the sheave will then engage with the lower coefficient of friction, metallic, groove-forming part of the sheave.

Metallic sheaves, such as iron and steel sheaves, whether lined or unlined, have generally been used since they are resilient to deformation and failure under elevator operation and other lifting applications. Entirely synthetic polymer-based sheaves, since they generally lack the resilience of structural metals, have not been applicable as sheave discs in conventional sheave assemblies, especially under high load, high-speed operating conditions.

Hence, heretofore, it has not been possible to use substantially or entirely synthetic sheave discs in elevator sheave assemblies or in similar, critical sheave applications. Further, heretofore it has not been practical to use U-groove type sheaves, nor obtain the advantages thereof, in a single wrap elevator system.

### SUMMARY OF THE INVENTION

The invention provides sheave discs wherein the groove-forming peripheral part of the sheave disc itself is at least substantially composed of synthetic polymeric material. In contrast, the groove-forming part of prior art sheaves have been metallic and have only been lined with synthetic materials.

The invention provides modular elevator sheave assembly systems having a component comprising a sheave disc support member and a plurality of sheave discs having an inner perimeter and an outer diameter, wherein the inner perimeter is sized to fit on the outer perimeter of the sheave disc support member of the first component. Sheave disc flanking flanges are further provided. These flanges laterally support the sheave discs and allow sheave discs which are predominantly or even entirely composed of synthetic polymer materials to be used.

The invention further provides that the sheave discs are at least substantially non-rope-pinching. Thus the sheave discs may have at least substantially U-shaped rope engaging grooves. The invention still further provides that at least the groove-forming part of the sheave is at least substantially composed of synthetic polymeric materials.

The modular sheave assemblies of the invention are suitable for both elevator drive sheave and deflector sheave applications. In drive sheave applications, durable synthetic polymer sheaves providing a high friction of coefficient rope-engaging surface are employed. For example, a synthetic polymeric material having a coefficient of friction of about 0.2 is sufficient for the raising and lowering of an elevator car using nylon jacketed, aramid fiber suspension rope, such as Kevlar rope, in slow or high-speed operation, using sheave discs having U-shaped channels.

In deflector sheave applications, the sheave channel need not present a high friction surface, and preferably presents a low friction surface so as to minimize the wear of the support cable or rope that engages with the channel. For example, sheave discs composed entirely or predominantly with a synthetic material having a coefficient of friction of about 0.11 are well-suited for deflector sheave applications with nylon-jacketed Kevlar rope.

### BRIEF DESCRIPTION OF THE DRAWINGS

FIGS. 1A-1C show an interchangeable sheave disc according to the invention.

FIGS. 2A and 2B show a modular drive sheave assembly according to the invention.

FIGS. 3A and 3B shows a modular deflector sheave assembly according to the invention.

### DETAILED DESCRIPTION

The invention provides modular elevator sheave assembly systems having a component comprising a sheave disc support member and a plurality of sheave discs having an inner diameter and an outer diameter, the inner diameter being sized to fit on the outer diameter of the cylindrical sheave disc support member of the first component. The invention further provides that the sheave discs have at least substantially non-rope-pinching rope-engaging grooves, e.g., U-shaped grooves. The invention still further provides that the groove-forming part of the sheaves itself is composed, at least substantially, of synthetic polymeric material.

The modular sheave assemblies of the invention are suitable for both elevator drive sheave and deflector sheave applications. In drive sheave applications high friction, durable synthetic polymer sheaves are employed. For example, a synthetic polymeric material having a coefficient of friction of about 0.2 is sufficient for the raising and lowering of an elevator car using nylon-jacketed, aramid fiber suspension rope, such as Kevlar rope, rope, in slow or high-speed operation, using sheave discs having U-shaped channels.

In deflector sheave applications, the sheave channel need not present a high friction surface, and preferable presents a low friction surface so as to minimize the wear of the support cable or rope that engages with the channel. For example, sheave discs composed entirely or predominantly of a synthetic polymeric material having a coefficient of friction of about 0.11 are well-suited for deflector sheave applications.

It will be apparent to those skilled in the art that the selection of particular synthetic polymer materials to form the sheave discs of the invention will be determined by the particular physical properties of the ropes used with the sheaves and the requirements, for example, speed and load bearing requirements, of the particular supporting/lifting application.

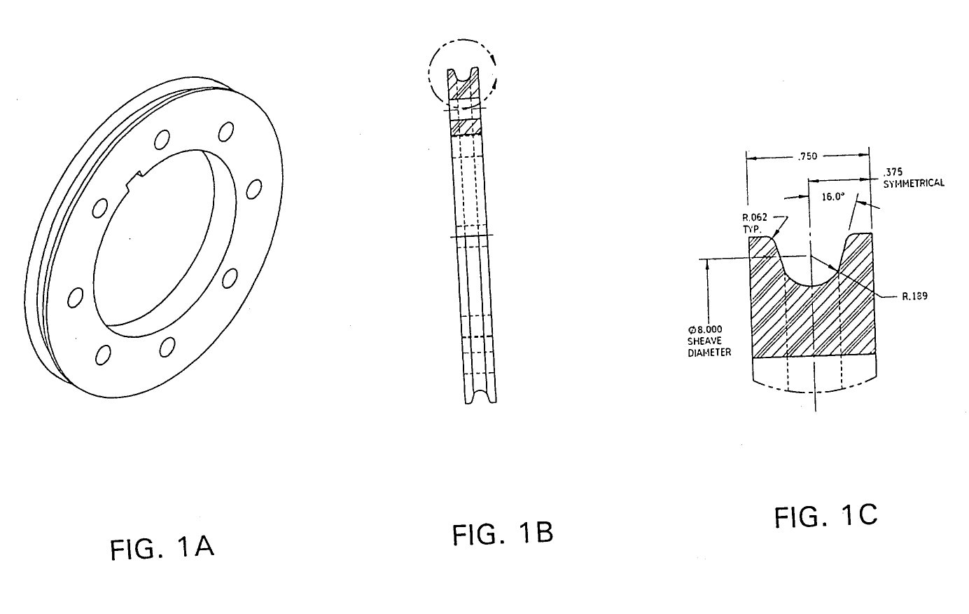

FIG. 1A shows an example of an interchangeable sheave disc according the invention. Eight holes are formed in the sheave disc to accommodate bolts or other types of tying members, which serve to tie the sheave discs, flanges and weldments together in the modular sheave assembly of the invention. A line-up keyway is also formed in the sheave disc of FIG. 1A. Similarly configured line-up key slots in the sheave discs and flanges used to form a modular sheave assembly permit the rapid alignment of the bolt holes therein by the progressives insertion of an elongated key through the key slots of neighboring discs and flanges. FIG. 1B shows an edge-wise view of the sheave disc shown in FIG. 1A, showing the non-rope-pinching configuration of the rope engagement slot of the sheave disc. FIG. 1C is a blow-up of the portion of the sheave-disc circled in FIG. 11B.

According to the invention, at least the groove-forming part of a sheave disc, including material below the lowest point of the sheave groove, is formed by an at least substantially, synthetic polymeric material, i.e., a resin-based material. Thus, in contrast to synthetic material lined-grooves of metallic sheaves, the sheaves of the present invention continuously provide a functioning, high-speed synthetic material groove surface as a groove is worn down over prolonged periods of operation.

In one embodiment of the invention, the entirety of the modular drive sheave discs are made of an at least substantially polymeric synthetic material, i.e., a resin material. In still another embodiment of the invention, an inner annulus of the modular sheave disc may be metallic or otherwise non-polymeric, but at least 10 mm of depth below the lowest point of the rope-engaging groove of the groove-forming part of the sheave is composed of the synthetic polymeric material. In still another embodiment of the invention, an inner annulus of the modular sheave disc may be metallic or otherwise non-polymeric, but from about 40 mm to about 100 mm of depth below the lowest point of the rope-engaging groove of the sheave is composed of an at least substantially or predominantly synthetic polymeric material. The synthetic polymer sheave discs, or synthetic polymer component of the sheave discs, of the invention may be manufactured, for example, by molding to form, by machining of “blanks” to form or by any combination of the two processes.

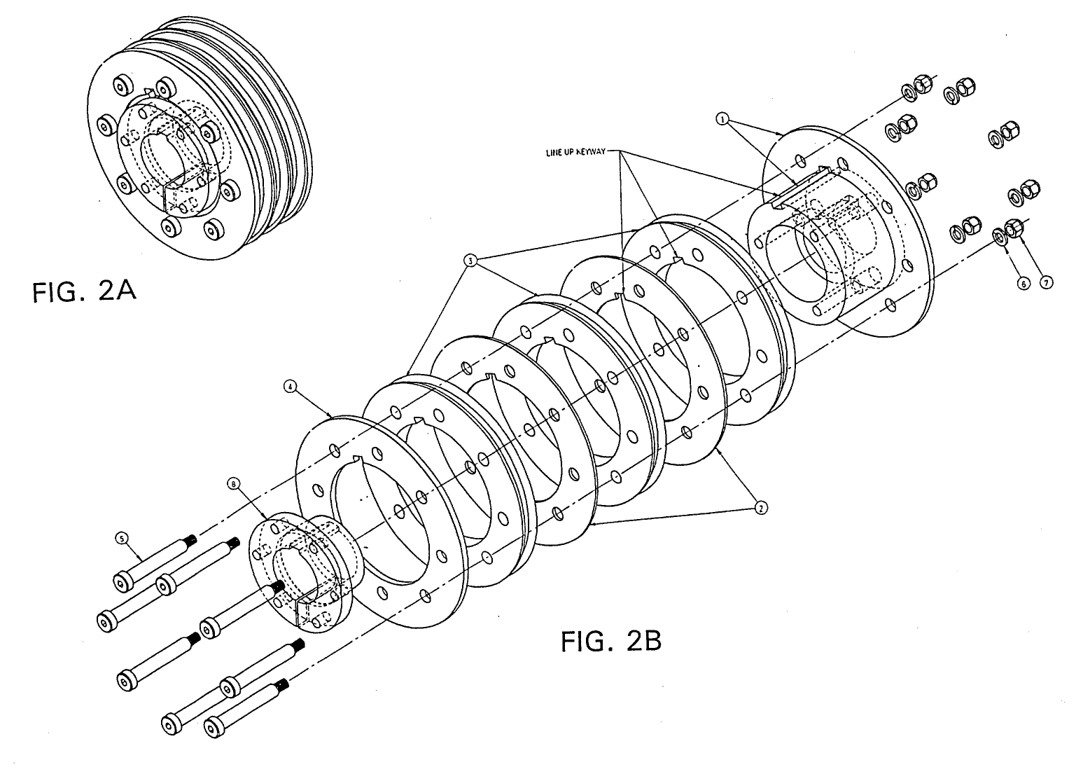

FIG. 2A shows an example of an assembled modular drive sheave assembly according to the invention. The modular drive sheave assembly of FIG. 2A has 3 component sheave discs and, hence, 3 rope-engagement grooves are shown. FIG. 2B is an exploded view drawing of the modular drive sheave assembly of FIG. 2A showing the relationship between its component parts. Member 1 is a sheave hub weldment drive which comprises an end-plate sheave flange and a cylindrical sheave disc and flange support member. Members 2 are intermediate sheave flanges which separate neighboring sheave discs. Members 3 are the synthetic drive sheave discs. Member 4 is an outside sheave flange. Each of members 1-4 has similarly configured holes so that bolts or other types of tying members can be passed through the consecutive members. Members 5 are screw threaded bolts and members 6 and 7 are spring-type washers and nuts, respectively, for tightening down and securing the bolts. Member 8 is an expansion-type bushing having an end-plate component and a cylindrical shaft component. The cylindrical shaft component of bushing member 8 has an inner recess diameter for accepting a support shaft and an outer diameter which is sized and configured to fit into a similarly dimensioned inner recess in the sheave and flange support member of member 1. Further, the shaft of the bushing has a longitudinal projection projecting radially from the main diameter of the shaft which interlocks with a similarly sized longitudinal recess within the main recess of the sheave and flange support member of member 1. The end plate of bushing member 8 also has holes through which bolts or other tying members can pass in order to secure member 8 to the sheave and flange support member of member 1.

Advantageously, the invention provides modular drive sheave discs with grooves having a non-rope-pinching configuration, yet which (1) provide a suitable degree of traction for high speed elevator operation using aramid fiber suspension ropes, such as, nylon-jacketed Kevlar suspension ropes and (2) which are formed themselves of the synthetic tractive material so that a functioning, high-speed-capable, synthetic groove surface is continuously provided as a groove is progressively worn down.

Suitable synthetic polymeric materials for the entirely polymeric drive sheave discs of the invention or those wherein only an inner annulus is metallic or non-polymeric include, for example, those having a coefficient of friction of about 0.2. Such a material provides good traction in connection with a nylon-jacketed Kevlar elevator suspension rope and enables high speed elevator operation therewith. Furthermore, synthetic polymeric materials further having a tensile strength of about 25 N/mm² and a hardness of in the range of about 80 to about 85 shore D provide favorable mechanical strength and wear characteristics under the same operating conditions. One such material is the resin-based, thermosetting plastic material, trade name Becorit D 670 BT. This material provides a substantially constant friction value under various conditions, including aqueous submersion, and is highly abrasion resistant. Additionally, Becorit D 670 BT is non-swelling and is generally resistant to oils and greases.

The sheave disc-flanking flanges provide lateral support to the sheave discs, for both the drive sheave and deflector sheave embodiments of the invention, and generally facilitate the use the non-metallic, resin-based sheave discs of the invention. Specifically, since the synthetic polymeric materials of which the sheave discs are composed will generally not be as resilient to failure or structural deformation, especially lateral deformation, as a metallic sheave disc, the sheave flanking flanges play an important role in constraining and maintaining the structure of the sheave discs during their operation within a sheave disc assembly according to the invention. One important aspect of this is that the flanges help maintain the groove in a constant, laterally-stabilized or “centered” alignment as the ropes progressively wear the groove down. Hence, the flanges minimize lateral travel of the groove itself. Accordingly, the flanges of the invention may be composed, for example, of a high-strength material such as, but not limited to, iron, steel or another metal or alloy or a carbon fiber composite material.

Further, in the event of failure of a synthetic sheave disc within the sheave disc assemblies of the invention, the flanges themselves advantageously form a laterally constraining rope groove which serves to keep the rope from traveling in a hazardous fashion.

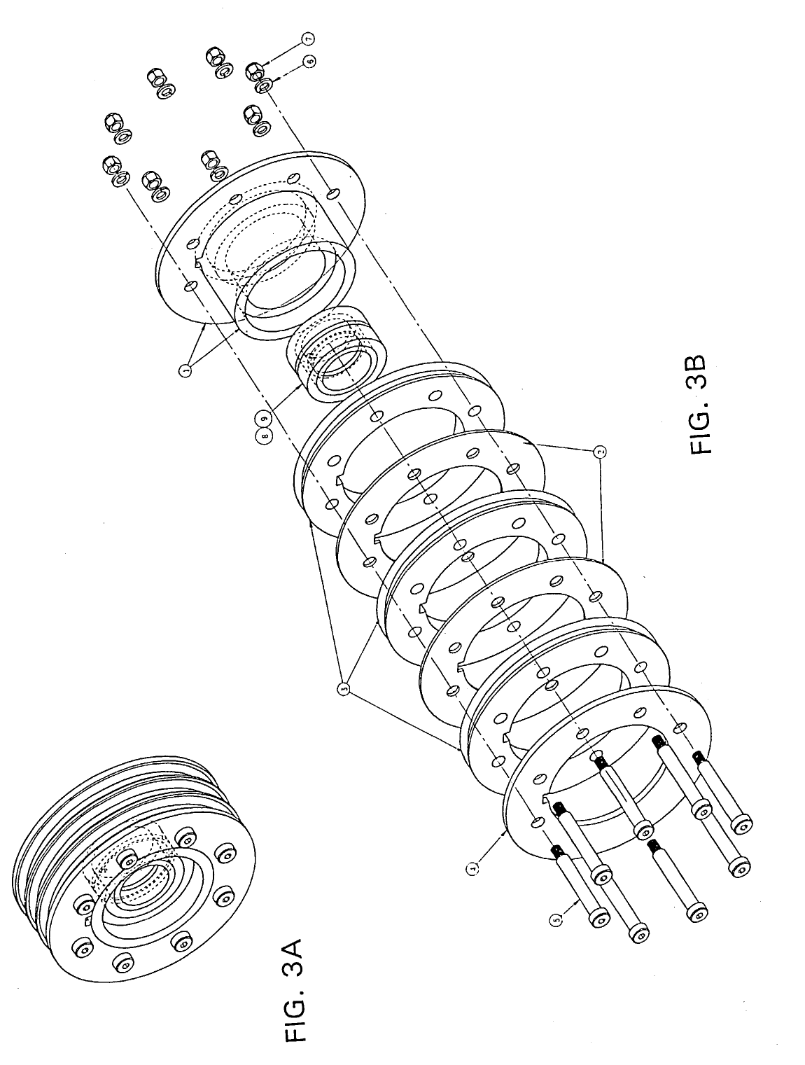

FIG. 3A shows an example of an assembled modular deflector sheave assembly according to the invention. The modular drive sheave assembly of FIG. 3A has 3 component sheave discs and, hence, 3 rope-engagement grooves are shown. FIG. 3B is an exploded view drawing of the modular drive sheave assembly of FIG. 2A showing the relationship between its component parts. Member 1 is a sheave hub deflector weldment which comprises an end-plate sheave flange and a cylindrical sheave disc and flange support member. Members 2 are intermediate sheave flanges which separate neighboring sheave discs. Members 3 are the synthetic deflector sheave discs. Member 4 is an outside sheave flange. Each of members 1-4 has similarly configured holes so that bolts or other types of tying members can be passed through the consecutive members. Members 5 are screw threaded bolts and members 6 and 7 are spring-type washers and nuts, respectively, for tightening down and securing the bolts. Members 8 and 9 are a bearing and hub, respectively, which cooperate with each other to provide a freely rotatable hub on which the sheave and flange support member of member 1, and the members supported thereon, may freely rotate. The bearing and hub subassembly formed by members 8 and 9 is sized and configured to fit in a complementary sized and configured inner recess within the sheave and flange support member of member 1.

Like the modular drive sheave discs, the invention also provides that the modular deflector sheave discs can be entirely composed of an at least substantially synthetic polymeric material, or that at least the groove forming part of the sheave is at least substantially composed of such a polymeric material.

Suitable synthetic polymeric materials for the entirely polymeric deflector sheave discs of the invention or those wherein only an inner annulus may be metallic or non-polymeric include, for example, those having a coefficient of friction of about 0.11. Such a material provides good cooperation between the sheave groove and nylon-jacketed Kevlar elevator suspension rope. Synthetic polymeric materials further having a tensile strength of about 27 N/mm² and a hardness of about 64 to about 67 shore D provide favorable mechanical strength and cause minimal wear to both the polymeric channel material and rope. One such polymeric material is the abrasion-resistant, thermoplastic material, trade name Becorit D 530 BT. This material is principally comprised of Macromelekel groups, plus additives and colorings agents. Further, Becorit D 530 BT is resistant against diluted acids, diluted alkalines, sulphuric acid (80%) and ethylene glycol. Other properties of this material include a permissible surface pressure of about 4.5 N/mm², elongation of about 450%, plastic hardness (DIN53456 H135 N) of about 38 N/mm² and volumetric weight (density) of about 0.94 g/cm².

Still another advantage of the modular sheave assembly design of the invention is that the modular sheaves can be readily disassembled and reassembled for inspection and replacement of worn component parts such as the sheave discs.

Further advantageously, the invention also provides a modular sheave system, for example, in the form of a kit, wherein common parts, such as intermediate flanges, end-plate flanges and sheave hub weldments and/or parts thereof, may be used interchangeably between modular drive sheave assemblies and modular deflector sheave assemblies.

The examples presented herein are intended to be illustrative and not limiting of the invention. Accordingly, the scope of the invention is to be determined solely in connection with the appended claims and their equivalents.

1. A modular sheave assembly system comprising:
a component comprising a cylindrical sheave disc support member;
at least one sheave disc, the sheave disc having an inner diameter and an outer diameter, the inner diameter being sized to fit on the outer diameter of the cylindrical sheave disc support member and the sheave disc having a peripheral rope engagement groove.

2. The modular sheave assembly system according to claim 1, having more than one sheave disc.

3. The modular sheave assembly system according to claim 1, wherein the rope engagement groove has an at least substantially non-rope pinching configuration.

4. The modular sheave assembly system according to claim 1 or 2, wherein the groove-forming part of the sheaves are at least substantially composed of an at least substantially synthetic polymeric material.

5. The modular sheave assembly system according to claim 4, wherein the synthetic polymeric material has a coefficient of friction of about 0.2.

6. The modular assembly system according to claim 4, wherein the synthetic material has a coefficient of friction of about 0.11.

7. A modular drive sheave assembly system comprising
a component comprising a cylindrical sheave disc support member;
a plurality of sheave discs having an inner diameter and an outer diameter, the inner diameter being sized to fit on the sheave disc support member and each sheave disc having a peripheral rope engagement groove.

8. The modular drive sheave assembly system according to claim 7, wherein the rope engagement groove has an at least substantially non-rope-pinching configuration.

9. The modular drive sheave assembly system according to claim 7 or 8, further comprising sheave disc-flanking flange members.

10. A modular deflector sheave assembly system comprising
a component comprising a cylindrical sheave disc support member having an outer diameter and an inner diameter;
an inner hub on which the component is rotatably supportable about its inner diameter;
a plurality of sheave discs having an inner diameter and an outer diameter, the inner diameter being sized to fit about the outer diameter of the sheave disc support member of the first component and each sheave disc having a peripheral rope engagement groove.

11. The modular deflector sheave assembly system according to claim 10, wherein the rope engagement groove has an at least substantially non-rope-pinching configuration.

12. The modular drive sheave assembly system according to claim 10 or 11, further comprising sheave disc-flanking flange members.

13. A modular elevator drive sheave assembly system comprising
a component comprising a cylindrical sheave disc support member;
a plurality of sheave discs each having an inner diameter and an outer diameter, the inner diameter being sized to fit on the sheave disc support member and each having a peripheral rope engagement groove, wherein
the rope engagement grooves have a non-rope-pinching configuration, and
at least the groove-forming part of the sheaves being at least substantially composed of an at least partially synthetic polymeric material having a sufficient coefficient of friction to provide sufficient traction between the sheave assembly and a nylon-jacketed aramid fiber suspension ropes engaged therewith, to provide high speed operation of an elevator car suspended from the ropes.

14. The system according to claim 13, wherein the synthetic polymeric material has a coefficient to friction of about 0.2.

15. The system according to claim 14, wherein the synthetic polymeric material has a tensile strength of about 25 N/mm² and a hardness in the range of about 80 to about 85 shore D.

16. The system according to claim 15, wherein the synthetic polymeric material is Becorit D 670 BT.

17. The system according to any one of claims 13-16, wherein the sheave discs are predominantly or entirely composed of the synthetic polymeric material.

18. A single wrap elevator system comprising:
(a) the modular elevator drive sheave assembly system according to any one of claims 13-16, wherein the drive sheave discs are securably mounted on the sheave disc support member;
(b) at least one nylon-jacketed, aramid fiber suspension rope engaged with the rope engagement groove of at least one of the drive sheave discs, the extent of engagement between a rope and the drive sheave disc with which it is engaged not exceeding 180°;
(c) an elevator car directly or indirectly attached to and supported by the nylon-jacketed, aramid fiber support ropes.

19. The elevator system according to claim 18, further comprising:
(d) a counterweight directly or indirectly attached to and supported by the nylon-jacketed aramid fiber support ropes.

20. The elevator system according to claim 18, wherein the support ropes are nylon-jacketed, Kevlar support ropes.

21. The elevator system according to claim 19, wherein the support ropes are nylon-jacketed, Kevlar support ropes.

22. The elevator system according to claim 18, wherein the sheave disc assembly further comprises sheave disc-flanking flange members.

23. The elevator system according to claim 19, wherein the sheave disc assembly further comprises sheave disc-flanking flange members.

23. The elevator system according to claim 22, wherein the support ropes are nylon-jacketed, Kevlar support ropes.
